(19) United States
(12) Patent Application Publication
(10) Pub. No.: US 2016/0227814 A1
(43) Pub. Date: Aug. 11, 2016

(54) DISPOSITION INTRODUCED IN MACHINE FOR ICE-CREAM BARS

(71) Applicant: FINAMAC LLC, Miami, FL (US)

(72) Inventor: Marino Arpino, Santo Andre - SP (BR)

(21) Appl. No.: 15/016,184

(22) Filed: Feb. 4, 2016

(30) Foreign Application Priority Data
Feb. 6, 2015 (BR) 202015002611

(51) Int. Cl. A23G 9/26; A23G 9/22

(52) U.S. Cl. CPC A23G 9/26; A23G 9/221; A23G 9/227

(57) ABSTRACT

DISPOSITION INTRODUCED IN ICE-CREAM BAR MACHINE, designed as equipment capable of performing the molding, freezing, and unmolding of ice-creams bars, belonging to the field of food items. The current state of the art ice-cram bar machines have a tank full with a fluid kept at low temperatures, with a mechanical shaker, which moves the referred fluid, thus freezing the mixture of ice-cream bars within the stainless steel molds immersed in this tank; during this process, the sticks that will be part of the final product are inserted. After freezing, the molds are removed from the freezing tank and inserted into a tank filled with hot water for unmolding, extraction and later packing.

### FIELD OF APPLICATION

This utility model patent has as object a practical and innovative equipment model, intended for ice-cream bar freezing and unmolding, both water and also milk-based, belonging to the field of food items, to be used more precisely in popsicles and ice cream manufacturing, the first being water-based, such as those that present the flavor of pineapple, lime, etc., and also the milk-based, with flavors like chocolate, vanilla, etc., and with an original constructive disposition, intended to improve its use and performance in relation to the other models usually found in the market.

Therefore, the patent application in question has an equipment specially designed and developed to obtain great convenience and benefits, both in its operation as well as in its manufacture.

Another objective of this request is to submit a machine model for popsicles and ice cream with low costs for their industrial manufacturing, nevertheless compliant to the strength, security and convenience requirements, thus offering the consumers an additional option in the field market which, unlike the usual models, offers numerous possibilities and benefits to their users, becoming greatly accepted.

### BACKGROUND OF THE INVENTION

As it is well known by specialists on the subject, popsicles became much more popular after the recent fever of “MEXICAN PALETAS” and “ICE CREAM BAR”, manufactured by large companies on this foodstuff sector.

More specifically, the “Mexican paleta” is a popsicle or ice cream done with natural ingredients and volume of 130 mL approximately, well above the traditional ice-cream bars of 70 to 90 ml. It can also be made with different fillings, pieces of fruit or sprinkles. Its format is rectangular, big and very colorful, either by the variety of flavors or by solid particulates within the product.

This is a very appealing product, both in the visual aspect and in flavor. It is a worldwide success! While the “ICE CREAM BAR”, whose translation simple means “ice cream in a stick”, are made with aerated ice cream and chocolate fudge and until recently these products were manufactured only in industrial lines of large plants.

### THE STATE OF THE ART

The ice-cream bars machines have a tank in which a fluid is maintained at low temperature and agitated strongly, thus freezing the mixture of ice-cream bars within the stainless steel molds immersed in the tank.

During this process, the sticks that will be tied to ice-cream bars are inserted.

After freezing, the molds are removed from the freezing tank and inserted in a tank with hot water for unmolding, extraction and later sent to packaging.

Most of the equipment for the production of ice-cream bars uses this concept for decades. What changes is the type of freezing fluid, which can be alcohol, a brine or glycol, and the agitation system, that can be done by propellers or using pumps to circulate the fluid.

New methods were developed in automation of these operations, although the processes remained the same. The competition between manufacturers of ice-cream production machines was based only in tradition, on the basis of “who created the first machine”, or releasing models with small construction details that added little to no change in the final result of the ice cream produced.

The machines known as the state of the art never lost the face of “Box” and kept exactly the same constructive patterns for many years. A metal frame with a metallic tank, involved by folded sheets.

### SUMMARY OF THE INVENTION

Thinking about these problems that, after numerous research and studies, the inventor, person familiar with the field of application, created and developed the object of this patent, envisioning a machine for ice cream and popsicles in which not only the mechanical and functional qualities were considered in the design of its manufacture, but also the shape, the disposition and the layout of its parts and components which, properly positioned, have brought an increase in efficiency without further expenses.

Thus, the following patent was designed to obtain a product with a smaller number of parts as possible, conveniently configured and arranged to allow the machine for ice cream production to perform its functions with unmatched efficiency and versatility, without the disadvantages mentioned before.

It is presented in this patent application a practical and innovative machine model for ice cream and popsicle with all the aesthetic and functional qualities, designed and developed in accordance with the most modern techniques, thus allowing its use in a wide range, from food courts up to small businesses, as also in industrial use in different cases.

Its innovative format allows to reach an excellent level of functionality, offering a machine model with high durability, having been designed to produce the two types of ice-cream bars mentioned previously, in addition to all the other already existing on the market.

The machine in question did not require a specialized operator, which enables its installation in any type of trade and not only on food courts.

The equipment layout, the object of this patent, in this new constructive way is the result of the observation and study of many years, and was developed to change the same old way the equipment for the production of ice-cream bars around the world currently are.

It has an absolutely innovative design, in a way that all construction details of this equipment meet current standards, both sanitary and functionality.

This machine for ice-cream bars represents the end of machines with that “Box” look, this way ending the concept that the machine needs to be hidden from the end customer, because its appearance is not aesthetically appealing, being clumsy and little hygienic.

Its innovative structure is based on aircraft technology, with single-piece chassis built using a high resistance material compound coupled with stainless steel, which involves tanks and all other components within a single package, without any amendments. With bold lines, its ergonomic design allows total comfort to the operator, in addition to the enormous ease of cleaning and sanitizing.

Just like the cars in Formula 1, its resistance is greater than steel, its weight is much lower and it can be built in different colors. It is the first ice-cream bars machine in the world with this type of integral construction. Everything in it is smooth, clean and visually stunning. It is not a “machine”, is a source of ice-cream bars of high quality, limpid and thin.

Advantages:

1. This is a quick and convenient equipment, which will help many new business-owners to start a promising business.

2. It is the business with lower investment and bigger return rate within the food industry.

3. It is the only business where people can start production even in its home. Works with electrical power Single-phase residential or business.

4. Requires no previous knowledge about the manufacture of ice-cream bars.

5. Easy to operate, easy to install, easy to transport.

6. Maintenance can be made by a common domestic refrigerator technician.

7. Occupies only 40% of the space usually occupied by an equivalent conventional equipment.

8. Has the largest production rate in comparison with equivalent conventional equipment, both national and imported.

9. It is the ultimate ice-cream bars production technology. Not even imported equipment use this unique system.

10. Durable and sellable.

The machine for ice-cream bars is able to produce ice-cream bars with several other new features never seen in the market before. The popsicle will no longer be only a chilled snack.

After many years of research the inventor of the object of this patent application has discovered a new freezing fluid, which will be provided along with the equipment. It is a special fluid for ice-cream bars freezing, which also serves to unmolding.

The first ice-cream bars machines used a mixture of water and salt to freeze the molds. The strong corrosion power of salt ate away many components of the equipment and the site where the machine was installed. Alcohol was adopted as a substitute to the brine, but its major problem is that he is flammable. Then propylene glycol started being used, a substance similar to that used in automotive radiators. This product has the inconvenience of having to be mixed with water and eventually becoming very viscous at low temperatures, which hinders their agitation.

Both alcohol and glycol are not good fluids for heat exchangers, and they are miscible with water. During the ice-cream bars manufacture process, these fluids absorb environment humidity and from the molds (which are immersed in hot water for unmolding, in conventional machines). The increase of the water fraction in the freezing fluid greatly slows the solidification time of the ice-cream bars.

The new fluid is a compound that has a high thermal conductivity and its viscosity varies very little, even in extremely cold temperatures. Besides, it does not absorb water nor is mixed with it. Is nontoxic, non-flammable and meets all health standards.

Because of that the ice-cream bars machine has a new system of unmolding. The unmolding tank is part of the machine, positioned next to the tank of freezing and using the same fluid that is used for freezing, however heated, without the use of water heated as in conventional machines.

The result is a much faster, cleaner and more efficient ice-cream bars production. Its replacement rate is also very low, unlike other fluids that vaporize during the production process, thus needing to be replaced more often.

As a result, it is understandable that the equipment is extremely simple in its construction, therefore being easily feasible. However, excellent practical and functional results can be obtained, offering an innovative construction over known designs.

Idealized with an innovative design, it resulted in a harmonious set, with a rather peculiar and over all characteristic aspect, being that, in addition to the constructive aspect, the model stands out for its versatility and ease of use.

### BRIEF DESCRIPTION OF THE FIGURES

Next, for better understanding on how the “DISPOSITION INTRODUCED IN MACHINE FOR ICE-CREAM BARS”, that here is pleaded, is composed, illustrative drawings are annexed, where it can be seen:

FIG. 1—Shows a top-front perspective view of ice-cream bars machine, with the adapter for molds of reduced dimensions.

FIG. 2—Shows a top-front perspective view of ice-cream bars machine, with the top lid open.

FIG. 3—Shows a top-front perspective view of ice-cream bars machine, with the top lid open and the molds removed from the cooling tank.

FIG. 4—Shows a top-front perspective view of ice-cream bars machine, with the top lid open and without the molds.

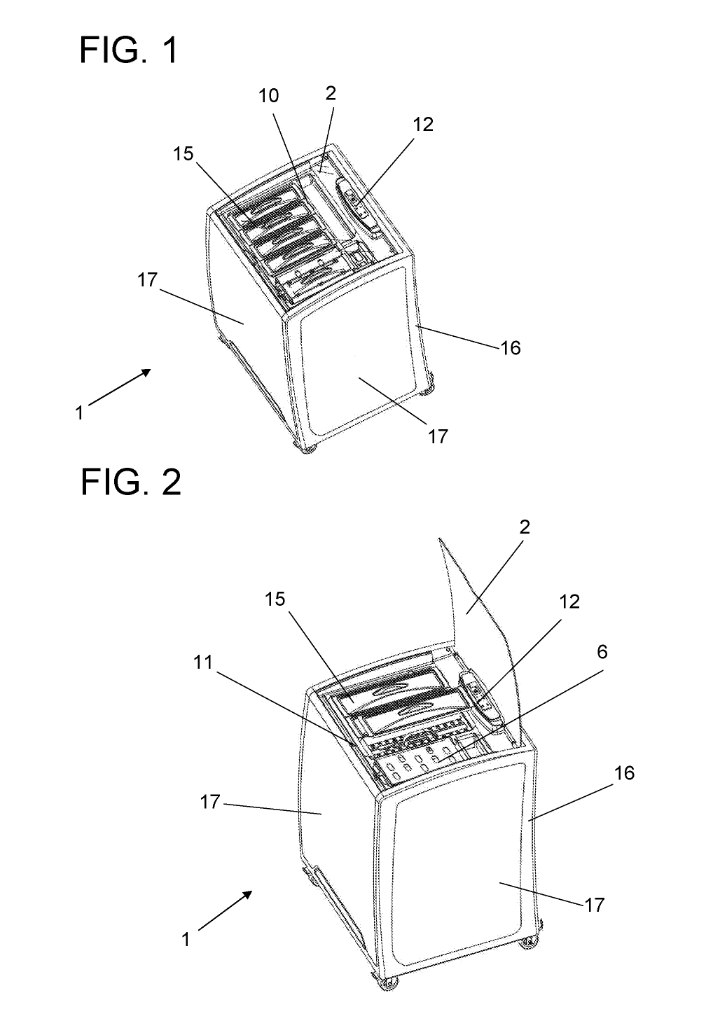

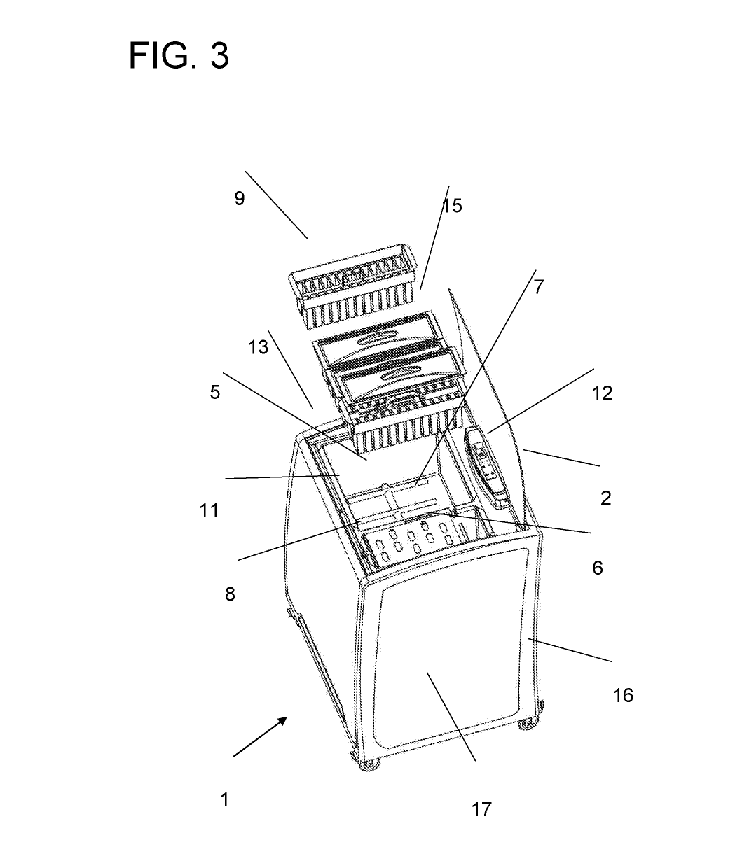

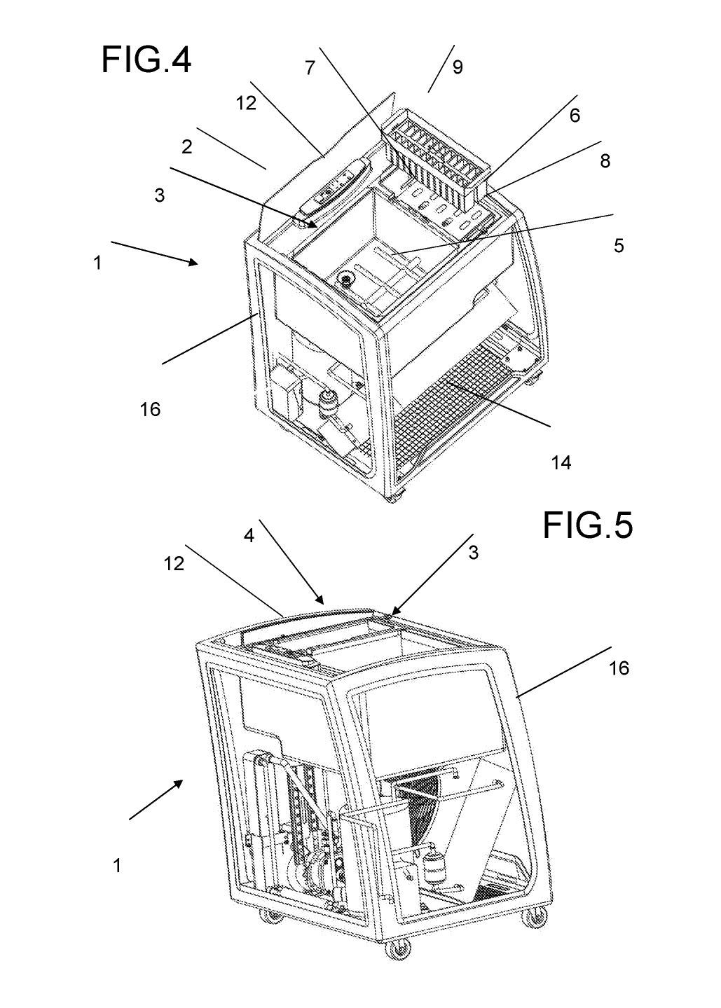

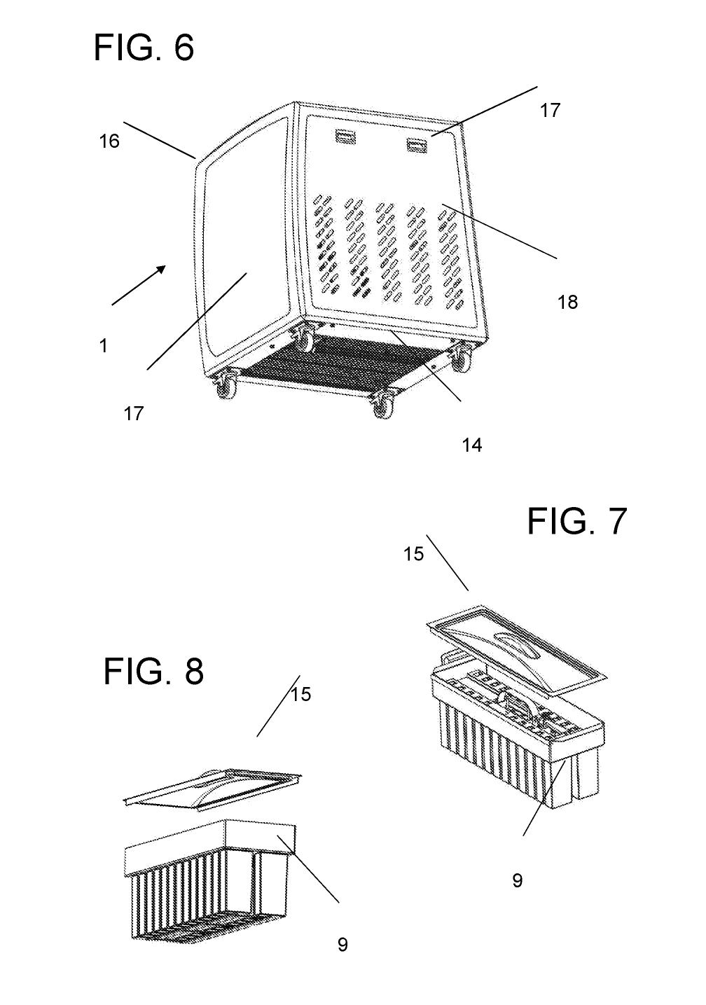

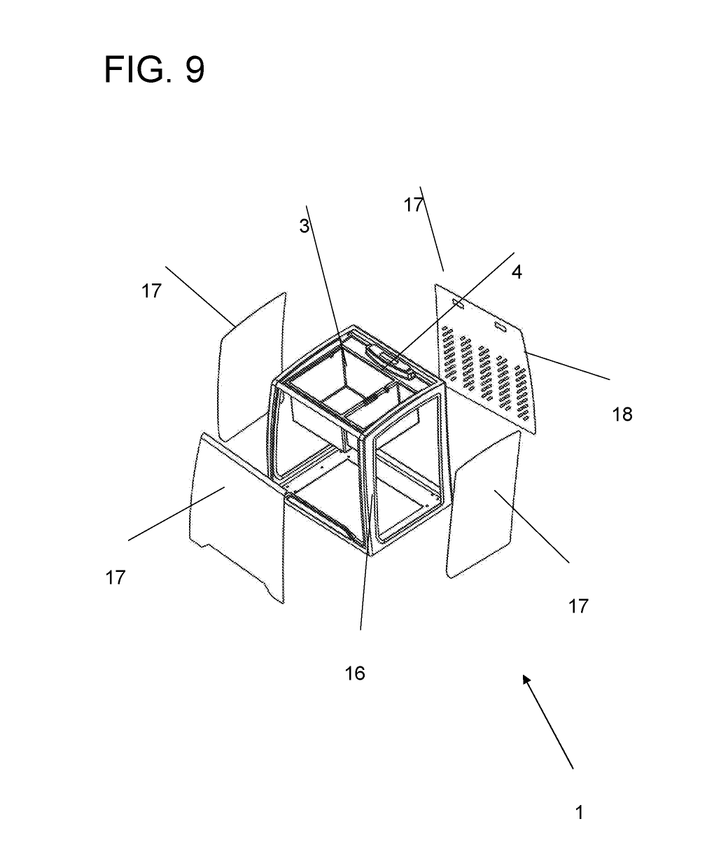

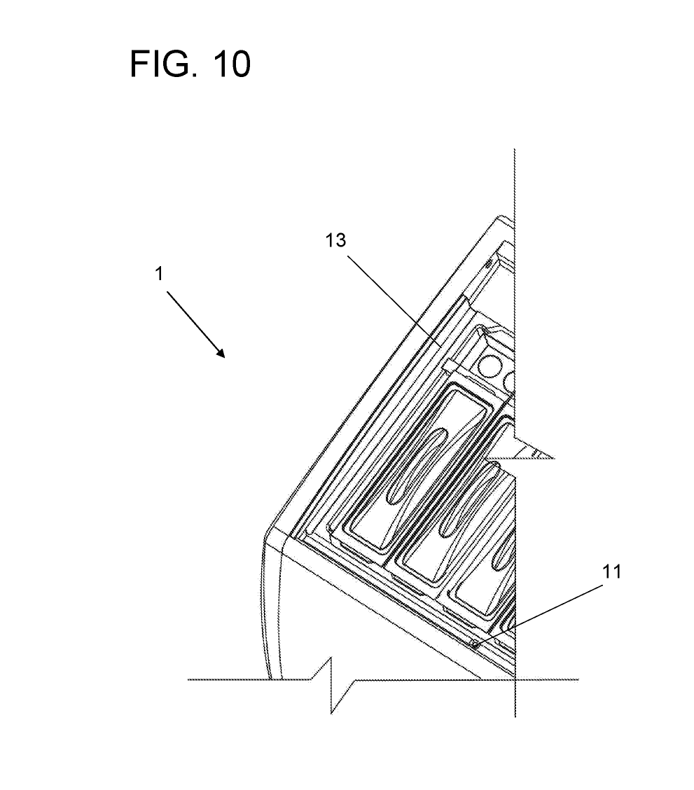

The FIG. 5—Shows a side-back perspective view of ice-cream bars machine without the side walls, where you can observe his internal mechanism.

The FIG. 6—Shows a bottom-back perspective view of ice-cream bars machine.

The FIG. 7—Shows a top perspective view of ice-cream bars mold.

The FIG. 8—Shows a bottom perspective view of ice-cream bars mold.

The FIG. 9—Shows a top-front perspective view of ice-cream bars machine chassis.

The FIG. 10—Shows a perspective view of the top chassis detail of the ice-cream bar machine, emphasizing the outlet channels and the drain hole in the front.

### DETAILED DESCRIPTION OF THE EMBODIMENTS

In accordance with the extent of information illustrated in the figures above, the “DISPOSITION INTRODUCED IN MACHINE FOR ICE-CREAM BARS”, object of this patent is made of a rectangular prismatic chassis (1), whose upper face is open in its entirety and has a dumping glass lid (2), which opens backwards, which occluded the freezing tank (3) and an unmolding tank (4) both with a quadrangular geometry and positioned laterally, but of different sizes, so that the freezing tank (3) occupies approximately four fifths of the total width of the chassis and the unmolding tank (4) the remainder, this proportion is only valid for the smaller machine model, which fits four molds. The larger model fits seven molds, and the unmold tank is equal on both.

More specifically the chassis of rectangular prismatic geometry (1) consists of a single structure (16) in compound material (glass fiber), with four columns, a basis (which contains a grid of stainless steel) and the two tanks (no amendments between all these parties, it is a single piece). Around this structure the closing plates are placed (17), made of stainless steel, on the sides, front and rear.

Both the freezing tank (3) and the unmolding tank (4) are covered externally by thermal insulating material, internally the cooling tank has in its lower portion a flow distributor (5) consisting of a stainless steel pipe, and the unmolding tank (4) has an electrical resistance in its lower inner portion.

On the upper face of the unmolding tank (4) There is a dumping unmold rack (6), composed by a rectangular plate attached to the side of the said tank (4) by hinges (7) and the front side have a lock (8), which attaches it in unmold tank structure (4). This is a new system to drain the fluid from the mold (9).

The perforated dumping support (6) serves as a base for the mold while it rests there for some time, dripping the remaining fluid from its external walls.

The extraction of ice-cream bars can be done over this base, as well as mold refilling with new mixture. This means that the ice-cream bars mold no longer needs to be brought to a table for the ice-cream bars withdrawal and mixture refilling.

The portion below the freezing (3) and unmolding (4) tanks is occupied by the mechanisms of cooling and heating, being that the bottom part of this compartment is composed by a grated plan or grid (14).

Both tanks (3) and (4), one for the ice-cream bars freezing (cold tank) and another, smaller, for unmolding them (hot tank), can accommodate the larger molds available, the “Mexican paletas” type. With optional adapters (10), it is also possible to use smaller molds. These tanks (3) and (4) use a smaller quantity of heat exchanger fluid due to the new system of agitation, and therefore the time that the machine needs to start the production cycle is significantly reduced. The edge of the upper face have channels and drains for the withdrawal of the fluid, either from the freezing tank or the unmolding tank. In each tank there is also a minimum level sensor which prevents the machine from operating without being properly filled with heat exchanger fluid. The level sensors do not appear on the images shown.

New system of heat exchanger fluid agitation. The same system of ultra-fast freezing used in large industrial machines was introduced in the machine for ice-cream bars, without any apparent loose part and fully washable. Below each mold is positioned a flow distributor (5) which causes a jet of heat exchanger fluid, making all molds freeze simultaneously, with 100% uniform freezing of ice-cream bars within each mold.

New tanks lid built in unique curved tempered glass, this lid allows the drops of water that eventually appear in its wall to run to the sides of the tank, where they are drained (11) to the rear of the machine. This prevents these drops from falling on the ice-cream bars which are being produced inside the tank, if the lid is closed. If the lid is opened, the drops on the lid can roll off by a channel that directs water to the drain (11).

New control panel (12), which is located in a safe place where there is little contact with moisture or heat exchange fluid and can be controlled with the glass lid either closed or open. All buttons are “Soft Touch” and security measures ensure the blocking of the operation in the event of a crash. The temperatures of the freezing tank and unmolding tank are controlled accurately.

New lids (15) for ice-cream bars molds to ensure total care of “NSF” health standards, each ice-cream bar mold (9) comes equipped with a transparent lid (15) that prevents impurities or water droplets to fall in its interior. They are easily removable and washable. They also help in the thermal insulation of ice-cream bars during production.

New ventilation system without grids, very common in conventional machines, the ice-cream bar machine aspirates air by the lower part of the equipment, through a grille or grid (14) and expels by the top rear, i.e. through the ventilation holes (18) of the rear closing plate (17), enabling the heat to exit through ducts or windows on the wall where the equipment is installed.

The lower part of the equipment is protected by a net or grid (14) to prevent of any type of foreign body to enter inside the moving parts of the machine.

From what has been stated above, it can be concluded that the “DISPOSITION INTRODUCED FOR ICE-CREAM BAR MACHINE” in question is characterized as a product of great utility, presenting all the practical and functionality qualities which fully justify the utility model patent application.

1. DISPOSITION INTRODUCED IN ICE-CREAM BAR MACHINE”, refers to an equipment able to perform the molding, freezing, and unmolding ice-cream bars, which presents an innovative construction over the state of the art ice-cream bars machines, which have a tank full with a fluid maintained at low temperature that has a mechanical shaker, which stirs the referred fluid, which in turn freezes the mixture of ice-cream bars within the stainless steel molds immersed in this tank, unlike the object of this patent application is characterized by being composed from a rectangular prismatic chassis (1), whose upper face is open in its entirety and has a curved glass dump lid (2), which opens to the rear, and covers a freezing tank (3) and an unmolding tank (4) both with quadrangular geometry and positioned laterally, tough with different sizes, in a way that the freezing tank (3) occupies approximately four fifths of the total width of the cabinet and the unmolding tank (4) the remainder. This proportion is only valid for the smaller machine model proposal, which fit four molds of ice cream, while the bigger model fits seven molds. The unmolding tank is equal on both. Internally the freezing tank has in its lower portion a flow distributor (5) consisting of pipes, while the unmolding tank (4) has an electrical resistances in its lower inner portion. On the upper side of the unmolding tank (4) there is a dumping unmolding rack (6), consisted by a rectangular plate attached to the side of the said tank (4) by hinges (7) and the front side have a lock (8), which attaches it in the unmolding tank structure (4). In the upper rim of the chassis drain holes (11) will be made, as well as draining channels (13).
